(19) United States
(12) Patent Application Publication
(10) Pub. No.: US 2012/0038806 A1
(43) Pub. Date: Feb. 16, 2012

(54) IMAGE SHOOTING DEVICE

(75) Inventors: Wataru FUNAMIZU, Yokohama-shi (JP); Hideki YAMANAKA, Yokohama-shi (JP)

(73) Assignee: NIKON CORPORATION, Tokyo (JP)

(21) Appl. No.: 13/207,689

(22) Filed: Aug. 11, 2011

(30) Foreign Application Priority Data
Aug. 16, 2010 (JP) 2010-181729

(51) Int. Cl. H04N 5/335

(52) U.S. Cl. 348/300; 348/E05.091

(57) ABSTRACT

An image shooting device includes: an image shooting part formed of a pixel array and a reading control part in which the pixel array includes a plurality of pixels arranged in a matrix form, each of the pixels having a photoelectric conversion part, a transfer transistor, an amplifying transistor, and a reset transistor, and the reading control part performs reading by switching a first reading control in which the reset transistor is controlled to be turned off before exposure to read the pixel signal from a part of rows of the pixel array and a second reading control in which the pixel signal is read from the pixel array after the exposure; and a correcting part correcting the pixel signal read through the second reading control based on the pixel signal read through the first reading control.

### CROSS-REFERENCE TO RELATED APPLICATION

This application is based upon and claims the benefit of priority from Japanese Patent Application No. 2010-181729, filed on Aug. 16, 2010, the entire contents of which is incorporated herein by reference.

### BACKGROUND

1. Field

The present invention relates to an image shooting device.

2. Description of the Related Art

A commonly used electronic camera has a solid-state image sensor such as a CCD sensor and a CMOS sensor mounted thereon. For example, when the CMOS sensor is used, charges which are accumulated, in accordance with incident light, in respective pixels arranged on a light-receiving surface in a matrix form are charge-voltage converted by pixel amplifiers to be read to vertical signal lines for each row. Subsequently, signals read from the respective pixels are read to the outside of the CMOS sensor via column amplifiers, a CDS circuit (correlated double sampling circuit), a horizontal output circuit and an output amplifier. However, the signals read from the CMOS sensor contain peculiar noise components in the row direction, such as a fixed pattern noise component and a dark shading component. Accordingly, in order to remove these noise components, there is used a technology in which image data read from the CMOS sensor after exposure is corrected by using correction data read from the CMOS sensor before the exposure (refer to Japanese Unexamined Patent Application Publication No. 2006-222689, for instance).

However, in order to reduce a period of time for obtaining the correction data, there is used a method of obtaining the correction data from only a part of rows of one screen, and in this case, an operating point of a pixel amplifier of a row from which the correction data is obtained and an operating point of a pixel amplifier of a row from which the correction data is not obtained are different, so that when the pixel amplifiers are used in the nonlinear region of their input-output characteristics, there is generated a difference in signal levels between the rows, resulting in that an image quality of shot image is deteriorated, which is a problem.

### SUMMARY

An image shooting device according to the present invention is characterized in that it includes: an image shooting part formed of a pixel array and a reading control part in which the pixel array includes a plurality of pixels, each of the pixels having a photoelectric conversion part which accumulates a charge in accordance with an amount of light, a transfer transistor which transfers the charge to a floating diffusion area, an amplifying transistor which outputs a pixel signal in accordance with the charge held in the floating diffusion area, and a reset transistor which resets the charge held in the floating diffusion area, and the reading control part performs reading by switching a first reading control in which the reset transistor is controlled to be turned off before exposure to read the pixel signal from a part of rows of the pixel array and a second reading control in which the pixel signal is read from the pixel array after the exposure; and a correcting part correcting the pixel signal read through the second reading control based on the pixel signal read through the first reading control.

Further, it is characterized in that in the first reading control, the transfer transistor is controlled to be turned off to read the pixel signal from the part of rows of the pixel array.

Furthermore, it is characterized in that in the first reading control, the reset transistor of a row from which the pixel signal is not read is controlled to be turned off.

Particularly, it is characterized in that in the first reading control, the pixel signal of a row located at a center portion of the pixel array is read.

According to the present invention, it is possible to remove noise components in a horizontal direction without deteriorating an image quality, even when input-output characteristics of pixel amplifiers are nonlinear.

### BRIEF DESCRIPTION OF THE DRAWINGS

FIG. 1 is a diagram illustrating an example of configuration of an electronic camera 100.

FIG. 2 is a flow chart illustrating an example of processing at a time of performing shooting.

FIG. 3 is a diagram illustrating an example of configuration of a solid-state image sensor 103.

FIG. 4 is a diagram illustrating an example of circuit of a pixel px.

FIG. 5 is a diagram illustrating noise components in a horizontal direction.

FIG. 6 is a diagram illustrating a correction data obtaining period and an image data obtaining period at a time of performing shooting.

FIG. 7 is a diagram illustrating an example of timings regarding a row from which correction data is obtained.

FIG. 8 is a diagram illustrating a characteristic of an on-resistance Ron of a reset transistor Trst.

FIG. 9 is a diagram illustrating an example of timings regarding a row from which correction data is not obtained.

FIG. 10A is a diagram illustrating a relation between characteristics of an amplifying transistor Tamp and a pixel output.

FIG. 10B is a diagram illustrating a relation between characteristics of an amplifying transistor Tamp and a pixel output.

FIG. 10C is a diagram illustrating a relation between characteristics of an amplifying transistor Tamp and a pixel output.

FIG. 11 is a diagram illustrating an example of timings regarding a row from which correction data is obtained in the present embodiment.

FIG. 12 is a diagram illustrating an example of timings regarding a row from which correction data is not obtained in the present embodiment.

### DETAILED DESCRIPTION OF THE EMBODIMENTS

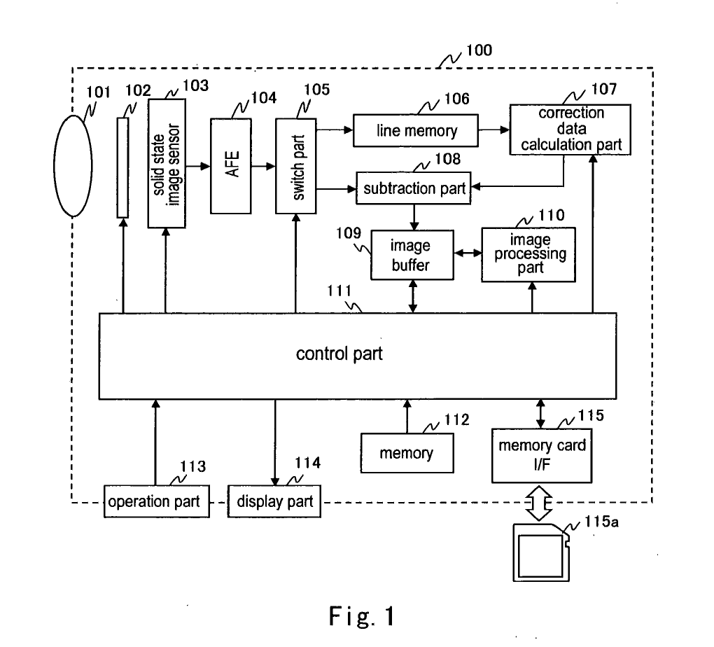

Hereinafter, embodiments of an image shooting device according to the present invention will be described in detail by using the drawings. FIG. 1 is a block diagram illustrating a configuration of an electronic camera 100 that corresponds to the image shooting device according to the present invention.

[Configuration of Electronic Camera 100]

In FIG. 1, the electronic camera 100 is formed of an optical system 101, a mechanical shutter 102, a solid-state image sensor 103, an AFE (analog front end) 104, a switch part 105, a line memory 106, a correction data calculation part 107, a subtraction part 108, an image buffer 109, an image processing part 110, a control part 111, a memory 112, an operation part 113, a display part 114, and a memory card I/F 115.

The optical system 101 forms an image of light input from a subject, on a light-receiving surface of the solid-state image sensor 103.

The mechanical shutter 102 is positioned between the optical system 101 and the solid-state image sensor 103, and at a time of exposure, it is opened and closed at a shutter speed indicated by the control part 111.

The solid-state image sensor 103 has the light-receiving surface on which pixels that convert light into electrical signals are arranged in a matrix form. Further, in accordance with an instruction of the control part 111, the solid-state image sensor 103 outputs signals read from respective pixels to the AFE 104.

The AFE 104 performs, in accordance with an instruction of the control part 111, gain adjustment, A/D conversion and the like of the signals read from the solid-state image sensor 103.

The switch part 105 switches, in accordance with an instruction of the control part 111, an output destination of data read from the solid-state image sensor 103 via the AFE 104. For instance, in order to obtain correction data, the control part 111 switches the switch part 105 to output unexposed data read from the solid-state image sensor 103 to the line memory 106. Alternatively, in order to obtain image data after exposure, the control part 111 switches the switch part 105 to output exposed data read from the solid-state image sensor 103 to the subtraction part 108. Here, the correction data is created from the unexposed data before the exposure, and the image data after the exposure is obtained by subtracting the correction data from the exposed data. Note that timings for obtaining data in a correction data obtaining period and an image data obtaining period will be described later in detail.

The line memory 106 is a buffer memory capable of holding one row or a plurality of rows of unexposed data read from the solid-state image sensor 103. Here, it is preferable that the unexposed data is read from a row located at a center portion of an image shot by the solid-state image sensor 103. This enables to obtain less biased correction data.

The correction data calculation part 107 creates the correction data from the unexposed data taken into the line memory 106. For instance, when a plurality of rows of unexposed data is obtained, the correction data calculation part 107 calculates, for each column, an average value of the plurality of rows of unexposed data taken into the line memory 106, thereby creating correction data of one row. Note that the correction data of one row has correction data for each column.

The subtraction part 108 subtracts the correction data previously created by the correction data calculation part 107 from the exposed data read from the solid-state image sensor 103 after the exposure to output the image data. At this time, the subtraction part 108 uses the correction data of the column corresponding to the same column of the exposed data.

The image buffer 109 is a buffer memory that temporality holds the image data output from the subtraction part 108. Further, the image buffer 109 is also used as a processing buffer of the image processing part 110. Note that there is no problem if the previously described line memory 106 and the image buffer 109 are configured by using physically the same memory whose memory area is divided.

The image processing part 110 performs image processing (color interpolation processing, gamma correction processing, edge enhancement processing and the like) indicated by the control part 111, on the image data stored in the image buffer 109.

The control part 111 is formed of a CPU that operates in accordance with a program code stored therein in advance, and controls operations of respective parts of the electronic camera 100 in accordance with contents of operations of respective operation buttons provided in the operation part 113. For example, the control part 111 performs opening and closing of the mechanical shutter 102, designates a row from which signals are read from the solid-state image sensor 103 and controls timings for reading the signals, performs gain setting and timing control of A/D conversion in the AFE 104, switches the switch part 105 to take a shot image into the image buffer 109, performs image processing by giving an instruction to the image processing part 110, and thereafter, it displays the shot image on the display part 114 and saves the image in a memory card 115a attached to the memory card I/F 115. Particularly, in the present embodiment, the control part 111 performs control of respective parts for obtaining correction data for correcting peculiar noise components in the horizontal direction. For example, in order to create the correction data, the control part 111 designates a row from which unexposed data is read from the solid-state image sensor 103, switches the switch part 105 to the line memory 106 side, and instructs the correction data calculation part 107 to create the correction data.

The memory 112 is a nonvolatile storage medium, and stores parameters and the like required for a shooting mode and operations of the electronic camera 100.

The operation part 113 has operation buttons such as a power button, a release button, and a mode selection dial, and outputs contents of operation to the control part 111 in accordance with an operation of a user.

The display part 114 is formed of a liquid crystal monitor, for example. Further, a setting menu screen output by the control part 111 and the shot image taken into the image buffer 109, or the shot image saved in the memory card 115a attached to the memory card I/F 115 and the like are displayed on the display part 114.

The memory card I/F 115 is an interface to which the memory card 115a is attached, and stores the image data output from the control part 111 in the memory card 115a. Alternatively, the memory card I/F 115 reads, in accordance with an instruction of the control part 111, the shot image data stored in the memory card 115a to output it to the control part 111.

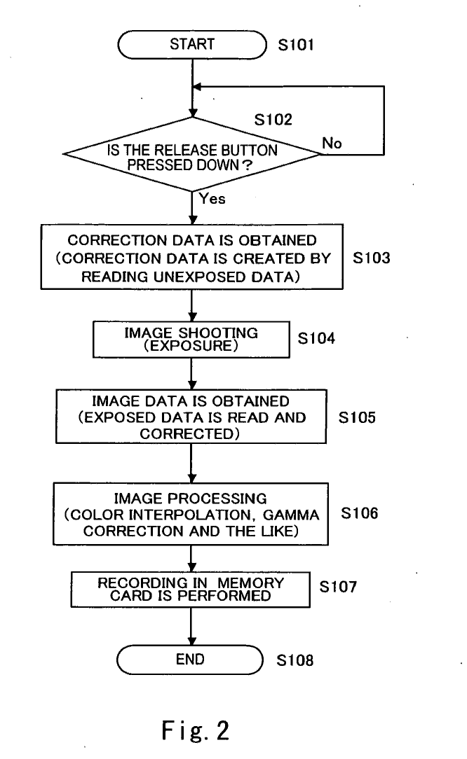

Here, a flow of shooting processing in the present embodiment performed by the control part 111 will be described by using a flow chart in FIG. 2. In FIG. 2, when a shooting mode is started (step S101), it is waited that the release button is pressed down (step S102). When the release button is pressed down, correction data is obtained (step S103), the mechanical shutter 102 is opened and closed to perform image shooting (exposure) (step S104). Subsequently, exposed data is read and corrected by the correction data obtained in step S103, thereby obtaining image data (step S105). After that, image processing such as color interpolation processing and gamma correction is performed (step S106), the resultant is saved in the memory card 115a (step S107), and the shooting processing is terminated (step S108).

As described above, the electronic camera 100 according to the present embodiment can shoot an image by performing correction processing for removing noise components in the horizontal direction.

[Configuration of Solid-State Image Sensor 103]

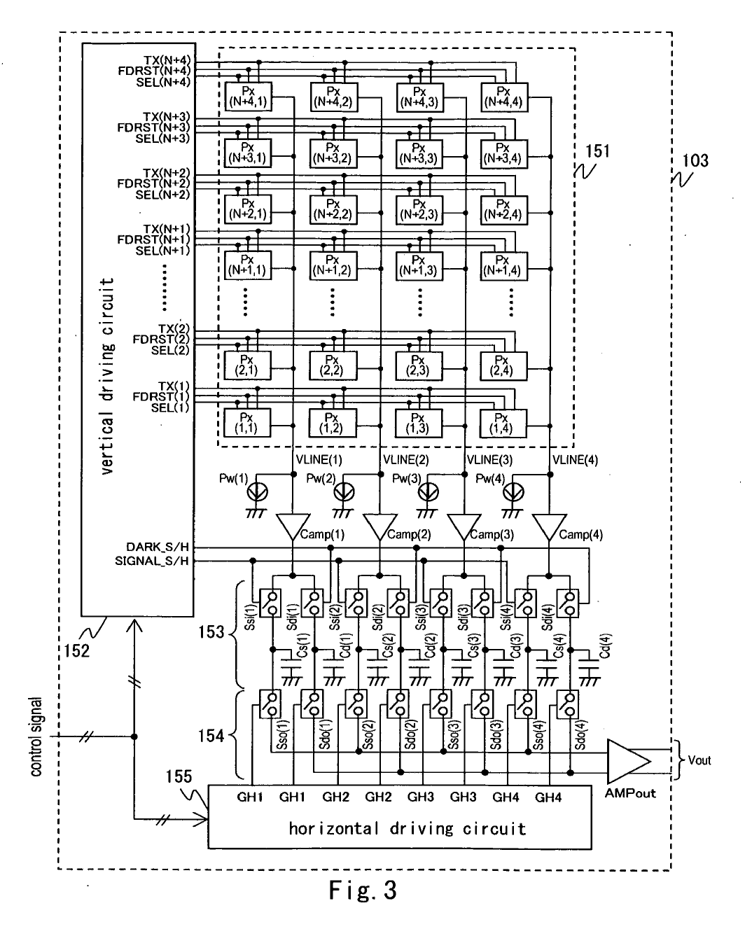

Next, the configuration of the solid-state image sensor 103 will be described. FIG. 3 is a block diagram illustrating an example of configuration of the solid-state image sensor 103. In FIG. 3, the solid-state image sensor 103 is formed of a pixel array 151 formed of a plurality of pixels Px, a vertical driving circuit 152, vertical signal lines VLINE, pixel current sources Pw, column amplifiers Camp, a CDS circuit 153, a horizontal output circuit 154, a horizontal driving circuit 155, and an output amplifier AMPout. Here, it is set such that when respective reference numerals are described with (n, m), (n), and (m) added thereto, they indicate specific pixels, rows or columns. Note that in FIG. 3, a pixel Px (n, m) indicates coordinates of each pixel, in which n is an integer from 1 to (N+4), and m is an integer from 1 to 4. For example, Px (2, 1) indicates a pixel in the second row and first column, VLINE (3) indicates a vertical signal line of the third column, and TX (N+2) indicates a transfer signal TX for the (N+2)-th row. Further, when (_) is not added to the respective reference numerals, namely, for example, when notation is made as the pixel Px, this indicates that the description thereof is common for all of the pixels, and when notation is made as the vertical signal line VLINE, this indicates that the description thereof is common for all of the vertical signal lines.

In the example of FIG. 3, there is illustrated the pixel array 151 with (N+4) rows and 4 columns having (N+4) pixels in the vertical direction and 4 pixels in the horizontal direction. Further, to respective pixels of the same rows, the same control signals are given from the vertical driving circuit 152 for each row. For example, to the four pixels of the (N+1)-th row (from the pixels Px (N+1, 1) to Px (N+1, 4)), three control signals (a transfer signal TX (N+1), a reset signal FDRST (N+1), and a selection signal SEL (N+1)) are given from the vertical driving circuit 152. Note that the same applies to the pixels of the first row, the second row, the (N+2)-th row, the (N+3)-th row, and the (N+4)-th row.

Further, outputs of the respective pixels of the same column are connected to the vertical signal line VLINE disposed for each column, and on the respective vertical signal lines VLINE, there are disposed the pixel current sources Pw that form transistors and source followers of the respective pixels, and signals read to the respective vertical signal lines VLINE are input into the column amplifiers Camp of the respective columns. For instance, the outputs of the respective pixels of the first column (from the pixels Px (N+4, 1) to Px (1, 1)) are connected to the vertical signal line VLINE (1), and input into the column amplifier Camp (1) in which the pixel current source Pw (1) is disposed. Note that the same applies to the outputs of the columns from the second column to the fourth column.

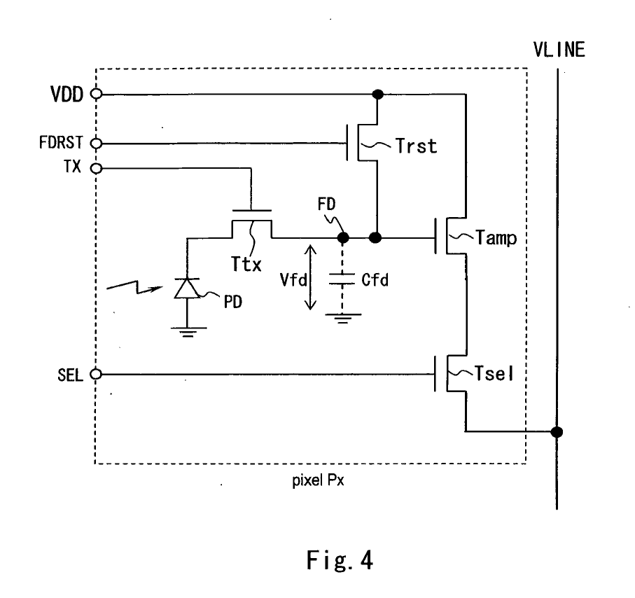

Here, a configuration of each pixel Px will be described by using FIG. 4. FIG. 4 is a circuit diagram of the pixel Px. In FIG. 4, the pixel Px is formed of a photodiode PD, a transfer transistor Ttx, a floating diffusion area FD, a reset transistor Trst, an amplifying transistor Tamp, and a selection transistor Tsel.

The photodiode PD generates and accumulates a charge in accordance with an amount of light incident from a subject.

The transfer transistor Ttx is turned on or off by a transfer signal TX output from the vertical driving circuit 152. For example, when the transfer signal TX is at High level, the transfer transistor Ttx is turned on, and the charge accumulated in the photodiode PD is transferred to the floating diffusion area FD.

The floating diffusion area FD forms a capacitor Cfd, which holds the charge transferred from the photodiode PD via the transfer transistor Ttx.

The reset transistor Trst is turned on or off by a reset signal FDRST output from the vertical driving circuit 152. For example, when the reset signal FDRST is at High level, the reset transistor Trst is turned on, and the charge held in the floating diffusion area FD is discharged to a power supply voltage VDD side, resulting in that a potential Vfd of the floating diffusion area FD is increased to the power supply voltage VDD.

The amplifying transistor Tamp converts the charge held in the floating diffusion area FD into a voltage signal.

The selection transistor Tsel is turned on or off by a selection signal SEL output from the vertical driving circuit 152. For example, when the selection signal SEL is at High level, the selection transistor Tsel is turned on, and the signal output from the amplifying transistor Tamp is read to the vertical signal line VLINE.

As described above, the charges accumulated in the photodiodes PD of the respective pixels Px of the pixel array 151 illustrated in FIG. 3 are once transferred to the floating diffusion areas FD, and after that, they are respectively read to the vertical signal lines VLINE (1) to VLINE (4) of the respective columns and respectively input into the column amplifiers Camp (1) to Camp (4) of the respective columns.

In FIG. 3, outputs of the column amplifiers Camp (1) to Camp (4) are input into the CDS circuit 153. The CDS circuit 153 is called as a correlated double sampling circuit, and is a circuit that removes an offset noise of each column from the respective pixels Px to the column amplifier Camp.

Here, an operation of the CDS circuit 153 will be described. The vertical driving circuit 152 reads a potential Vfd of the floating diffusion area FD (referred to as dark signal, hereinafter) before transferring the charge accumulated in the photodiode PD of the pixel Px to the floating diffusion area FD. Further, the vertical driving circuit 152 controls a dark sample-and-hold signal DARK_S/H in a period of time in which the dark signal is read, and holds the read dark signal in a dark capacitor Cd. Subsequently, the vertical driving circuit 152 transfers the charge accumulated in the photodiode PD of the pixel Px to the floating diffusion area FD, and then reads a potential Vfd of the floating diffusion area FD (referred to as PD signal, hereinafter). Further, the vertical driving circuit 152 controls a signal sample-and-hold signal SIGNAL_S/H in a period of time in which the PD signal is read, and holds the read PD signal in a signal capacitor Cs.

The horizontal output circuit 154 is formed of signal switches Sso and dark switches Sdo that switch whether or not the dark signals and the PD signals held in the signal capacitors Cs and the dark capacitors Cd disposed in the respective columns are output to the output amplifier AMPout. Further, in accordance with control signals (horizontal output signals GH1 to GH4) given by the horizontal driving circuit 155, the horizontal output circuit 154 reads the signals held in the respective capacitors to output them to the output amplifier AMPout in the order of columns. For example, with the use of the horizontal output signal GH1, the signal switch Sso (1) and the dark switch Sdo (1) are controlled, and the dark signal and the PD signal held in the signal capacitor Cs (1) and the dark capacitor Cd (1) are output to the output amplifier AMPout. In like manner, the respective signals of the second column are output to the output amplifier AMPout with the use of the horizontal output signal GH2, and the respective signals of the third column and the fourth column are output to the output amplifier AMPout with the use of the horizontal output signal GH3 and the horizontal output signal GH4, respectively.

In accordance with a control signal given by the control part 111, the horizontal driving circuit 155 generates the horizontal output signals GH1 to GH4, and controls on/off of the signal switches Sso and the dark switches Sdo.

The output amplifier AMPout is formed of a differential amplifier, for example, which subtracts the dark signal from the PD signal input from the horizontal output circuit 154 and outputs the resultant from the solid-state image sensor 103. Accordingly, a common mode noise of each column from the respective pixels Px to the column amplifier Camp can be removed. Note that the removal of offset noise of each column is completed by performing subtraction in the output amplifier AMPout, so that there is no problem if the CDS circuit 153 is configured by including the horizontal output circuit 154, the horizontal driving circuit 155 and the output amplifier AMPout. Alternatively, there is no problem if the subtraction of the dark signal from the PD signal is not performed in the output amplifier AMPout, and the subtraction processing is performed in the outside of the solid-state image sensor 103 (in the AFE 104, for example).

Here, although the CDS circuit 153 can remove the offset noise of each column, it cannot remove the noise component in the horizontal direction between the columns. For this reason, as described in the related art, there is a need to remove the peculiar noise components in the horizontal direction (row direction) such as the fixed pattern noise component and the dark shading component contained in the signals read from the solid-state image sensor 103.

[Description Regarding Correction Data]

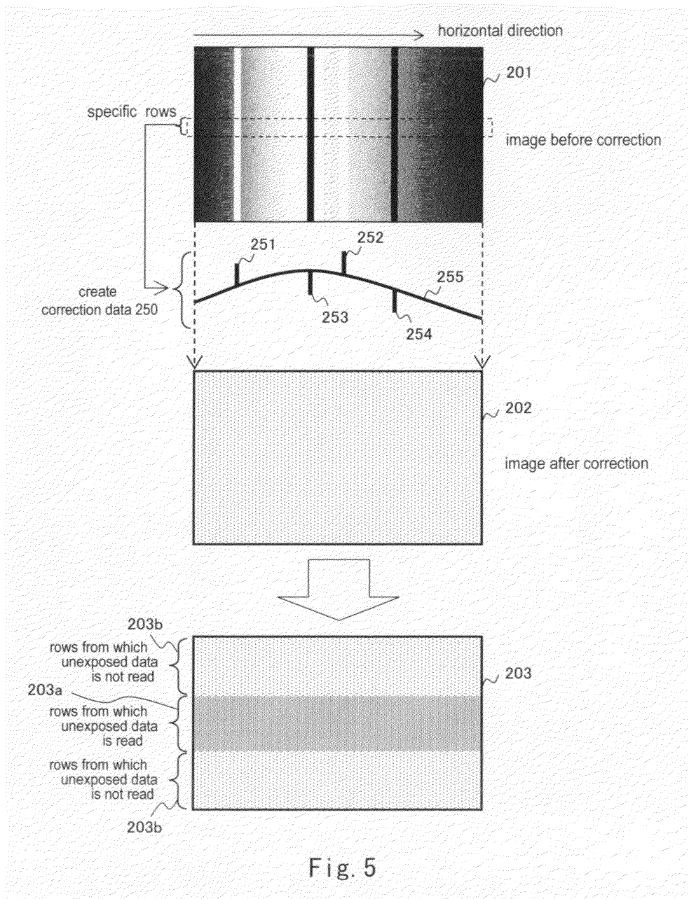

Next, explanation will be made on the correction data for removing the peculiar noise components in the horizontal direction such as the fixed pattern noise component and the dark shading component. FIG. 5 is a diagram for explaining correction processing. In FIG. 5, an image 201 illustrates an example of a case where the noise components in the horizontal direction are not removed (no correction is made). In the image 201 before correction, there are appeared, in the horizontal direction, white and black vertical stripes and a dark shading in which the color becomes gradually black from the vicinity of a center of the screen toward both left and right ends. Such noise components in the horizontal direction are similarly contained in both the unexposed data read from the solid-state image sensor 103 during the unexposed time in which the mechanical shutter 102 is closed and the exposed data read from the solid-state image sensor 103 after the exposure. Accordingly, by using the unexposed data read from a specific row set in advance before the exposure, correction data 250 indicating peculiar noise characteristics in the horizontal direction is created. Subsequently, the correction data 250 is subtracted from the exposed data read from the solid-state image sensor 103 after the exposure. Accordingly, the noise components in the horizontal direction contained in the exposed data with the same characteristics as those of the correction data 250 are removed, resulting in that an image 202 after correction with high image quality can be obtained. Note that in FIG. 5, it is assumed that light with uniform brightness is incident on an entire surface of the solid-state image sensor 103.

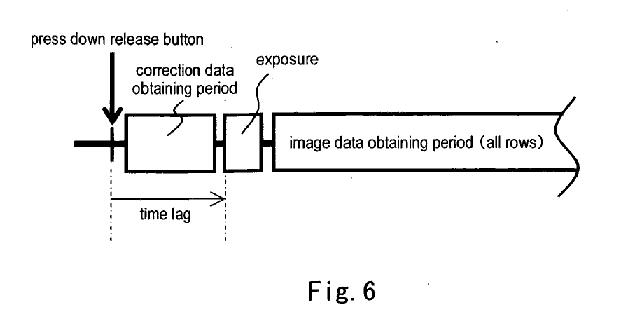

However, as illustrated in FIG. 6, the correction data obtaining period for reading the unexposed data has to be provided in a period of time from when the release button of the operation part 113 is pressed down to when the exposure is actually performed, so that if the unexposed data of all of the rows is read, the correction data obtaining period becomes long and a release time lag is increased, which is a problem. Accordingly, in order to reduce the release time lag, there is generally used a method of creating the correction data by reading the unexposed data, not from all of the rows but from a part of the rows of the solid-state image sensor 103. In this case, as illustrated in an image 203 in FIG. 5, there exist, in one screen, a row 203a from which the unexposed data is read and rows 203b from which the unexposed data is not read. In particular, when the pixel amplifiers (amplifying transistors Tamp) of the pixels Px are used in the nonlinear region of their characteristics, there is generated a potential difference in the potentials Vfd of the floating diffusion areas FD between the row 203a from which the unexposed data is read and the rows 203b from which the unexposed data is not read, so that there arises a problem that the color of the row 203a from which the unexposed data is obtained becomes black compared with the color of the rows 203b from which the unexposed data is not obtained, for example, as illustrated in the image 203 in FIG. 5.

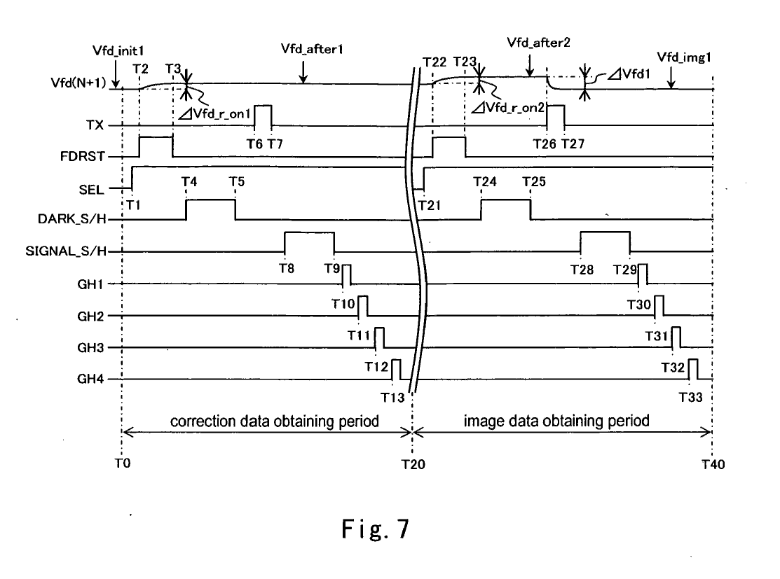

The cause thereof will be described by using FIG. 7. Here, it is set that the row from which the unexposed data is read to create the correction data is the (N+1)-th row, and the row from which the unexposed data is not read (the row which is not used for creating the correction data) is the (N+3)-th row in FIG. 3. FIG. 7 illustrates a timing chart of a correction data obtaining period and an image data obtaining period regarding the (N+1)-th row for obtaining the correction data in the related art. Note that in the correction data obtaining period, the unexposed data is read from the solid-state image sensor 103 to create the correction data, and in the image data obtaining period, the exposed data is read and the previously created correction data is subtracted from the exposed data, thereby creating the image data after correction.

In FIG. 7, control signals denoted by the same reference numerals as those in FIG. 3 and FIG. 4 indicate the same control signals. Further, before a timing T0, the transfer signal TX and the reset signal FDRST with respect to the transfer transistors Ttx and the reset transistors Trst of all of the pixels Px are both turned on, and the charge in the photodiodes PD and the charge in the floating diffusion areas FD are both initialized. Further, a voltage Vfd (N+1) of the floating diffusion area FD of the (N+1)-th row at the timing T0 is Vfd_init1. Here, since there are a plurality of pixels Px in the (N+1)-th row, the voltage Vfd (N+1) of the floating diffusion area FD is set to indicate the voltage Vfd of the floating diffusion area FD of any one of the pixels Px.

<Correction Data Obtaining Period>

At a timing T1, when the selection signal SEL becomes High and the selection transistor Tsel is turned on, the voltage Vfd of the floating diffusion area FD is read to the vertical signal line VLINE via the amplifying transistor Tamp and the selection transistor Tsel.

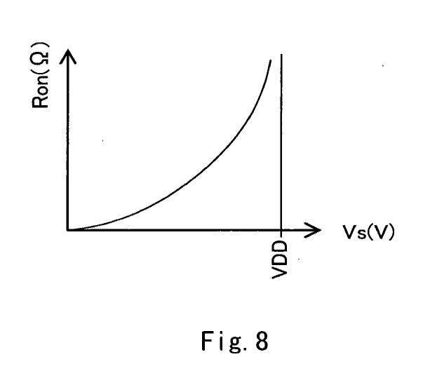

Ata timing T2, when the reset signal FDRST becomes High and the reset transistor Trst is turned on, the voltage Vfd of the floating diffusion area FD becomes close to a voltage of a power supply VDD. However, an on-resistance Ron of the reset transistor Trst becomes larger as a source potential Vs of the reset transistor Trst becomes close to the power supply voltage VDD, as illustrated in FIG. 8 (diagram illustrating characteristics of the source voltage Vs and the on-resistance Ron of the reset transistor Trst). For this reason, the potential Vfd of the floating diffusion area FD varies in accordance with a pulse width of the reset signal FDRST (interval between the timings T2 and T3) illustrated in FIG. 7. Here, if it is set that a potential of the floating diffusion area FD before the reset signal FDRST is set to High is Vfd_init1, and a potential of the floating diffusion area FD after the reset signal FDRST is set to High for a predetermined period of time (from the timings T2 to T3) is Vfd_after1, there is generated a potential difference ΔVfd_r_on1 in the signal read from the pixel Px by the reset signal FDRST.

At timings T4 to T5, when the dark sample-and-hold signal DARK_S/H becomes High, the potential Vfd_after1 of the floating diffusion area FD before the charge (signal charge) accumulated in the photodiode PD is transferred to the floating diffusion area FD is held in the dark capacitor Cd.

At timings T6 to T7, when the transfer signal TX becomes High, the signal charge in the photodiode PD is transferred to the floating diffusion area FD.

At timings T8 to T9, when the signal sample-and-hold signal SIGNAL_S/H becomes High, a voltage corresponding to the potential Vfd_after1 of the floating diffusion area FD after the signal charge in the photodiode PD is transferred to the floating diffusion area FD is held in the signal capacitor Cs. Here, the potentials of the floating diffusion area FD after and before the signal charge in the photodiode PD is transferred to the floating diffusion area FD become substantially the same potential Vfd_after1 because the signal charge in the photodiode PD is previously initialized.

At timings T10 to T13, short pulses of the horizontal output signals GH1 to GH4 in FIG. 7 are given by the horizontal driving circuit 155 to the respective signal switches Sso and dark switches Sdo, and the respective signals sampled and held by the signal capacitors Cs and the dark capacitors Cd are sequentially read by the output amplifier AMPout to be output from the solid-state image sensor 103 to the AFE 104.

Here, when unexposed data for creating the correction data is read from the (N+2)-th row as well, the unexposed data is read in the correction data obtaining period in a procedure similar to that of the timing chart explained in FIG. 7.

The unexposed data output to the AFE 104 as described above is held in the line memory 106 via the switch part 105, and the correction data is created by the correction data calculation part 107. For example, when the unexposed data is read from two rows of the (N+1)-th row and the (N+2)-th row, the unexposed data of two rows of the (N+1)-th row and the (N+2)-th row is held in the line memory 106. In this case, the correction data calculation part 107 determines an average value of the unexposed data of the (N+1)-th row and the unexposed data of the (N+2)-th row on the same column, to thereby create the correction data of the column. In like manner, the correction data calculation part 107 can obtain the correction data of one row by determining the correction data of each column.

<Image Data Obtaining Period>

Followed by the correction data obtaining period, a charge in accordance with an amount of incident light is accumulated in the photodiode PD of each pixel of the solid-state image sensor 103 (exposure), as illustrated in FIG. 6. Subsequently, the image data obtaining period illustrated in FIG. 7 is started. Note that it is assumed that the brightness of incident light is uniform with respect to the entire surface of the pixel array 151, for easier understanding of the characteristics.

In FIG. 7, the potential Vfd of the floating diffusion area FD at a timing T20 at which the correction data obtaining period ends and the image data obtaining period starts, is Vfd_after1.

At a timing T21, when the selection signal SEL becomes High and the selection transistor Tsel is turned on, the voltage Vfd of the floating diffusion area FD is read to the vertical signal line VLINE via the amplifying transistor Tamp and the selection transistor Tsel.

At a timing T22, when the reset signal FDRST becomes High and the reset transistor Trst is turned on, the voltage Vfd of the floating diffusion area FD becomes close to the voltage of the power supply VDD. However, similar to the case of the timing T2 in the correction data obtaining period, the potential Vfd of the floating diffusion area FD varies in accordance with a pulse width of the reset signal FDRST (interval between the timings T22 and T23), because of the characteristic of the on-resistance Ron of the reset transistor Trst. Further, as is the case with the correction data obtaining period, a potential difference ΔVfd_r_on1 is generated before and after the reset signal FDRST is output, and the potential Vfd_after1 of the floating diffusion area FD before the image data obtaining period starts becomes a potential Vfd_after2 of the floating diffusion area FD after the reset signal FDRST is set to High for a predetermined period of time (from the timings T22 to T23).

At timings T24 to T25, when the dark sample-and-hold signal DARK_S/H becomes High, a voltage corresponding to the potential Vfd_after2 of the floating diffusion area FD before the charge (signal charge) accumulated in the photodiode PD is transferred to the floating diffusion area FD is held in the dark capacitor Cd.

At timings T26 to T27, when the transfer signal TX becomes High, the signal charge in the photodiode PD is transferred to the floating diffusion area FD. In this case, since the exposure has been performed, the potential is decreased by a potential difference ΔVfd1 in accordance with the amount of light, resulting in that the floating diffusion area FD has a potential of Vfd_img1.

At timings T28 to T29, when the signal sample-and-hold signal SIGNALS/H becomes High, a voltage corresponding to the potential Vfd_img1 of the floating diffusion area FD after the signal charge in the photodiode PD is transferred to the floating diffusion area FD is held in the signal capacitor Cs.

At timings T30 to T33, short pulses of the horizontal output signals GH1 to GH4 in FIG. 7 are given by the horizontal driving circuit 155 to the respective signal switches Sso and dark switches Sdo, and the respective signals sampled and held by the signal capacitors Cs and the dark capacitors Cd are sequentially read by the output amplifier AMPout. Subsequently, a signal (ΔVfd1) as a result of subtracting the dark signal (Vfd_after2) from the PD signal (Vfd_img1) in the output amplifier AMPout is output from the solid-state image sensor 103 to the AFE 104.

The image data obtaining period of the (N+1)-th row ends at a timing T40, and similar processing from the timings T20 to T40 is repeatedly conducted with respect to all of the rows from which the unexposed data is read for obtaining the correction data.

The exposed data output to the AFE 104 as described above is output to the subtraction part 108 via the switch part 105. The subtraction part 108 subtracts the correction data generated by the correction data calculation part 107 in the correction data obtaining period from the exposed data, to thereby create the image data as a result of removing the noise components in the horizontal direction. For example, in FIG. 3, correction data of the first column of the previously created correction data is subtracted from exposed data read from the pixel Px (N+1, 1), to thereby determine image data of the pixel Px (N+1, 1). In like manner, correction data of the second column is subtracted from exposed data read from the pixel Px (N+1, 2) to determine image data of the pixel Px (N+1, 2), and correction data of the third column and correction data of the fourth column are respectively subtracted from exposed data read from the pixel Px (N+1, 3) and that read from the pixel Px (N+1, 3) to determine image data of the pixel Px (N+1, 3) and that of the pixel Px (N+1, 4), respectively.

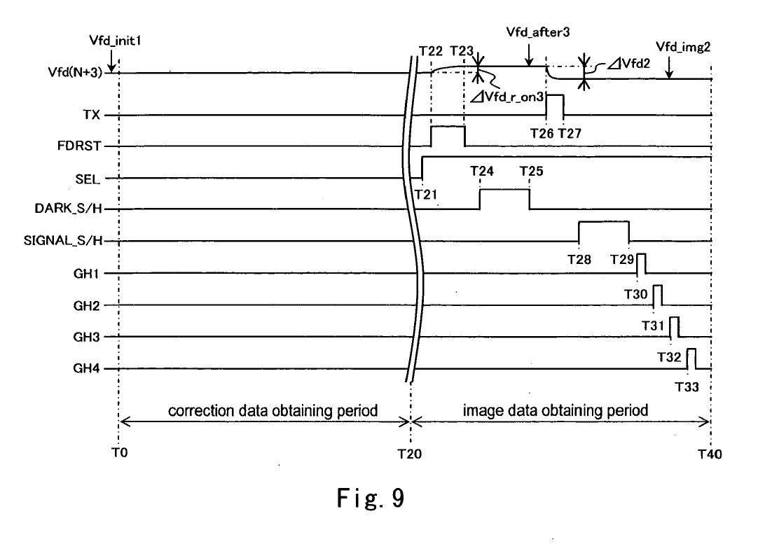

Next, explanation will be made on a case of a row from which the unexposed data for creating the correction data is not read (the (N+3)-th row, for example) by using a timing chart in FIG. 9. Note that elements denoted by the same reference numerals as those of the timing chart in FIG. 7 indicate the same elements. For example, the transfer signal TX, the reset signal FDRST, the selection signal SEL, the dark sample-and-hold signal DARK_S/H, the signal sample-and-hold signal SIGNAL_S/H, and the horizontal output signals GH1 to GH4 are output at the same timings as those in FIG. 7, from the timings T20 to T40 in the image data obtaining period.

Meanwhile, also in the (N+3)-th row from which the unexposed data for creating the correction data is not read, the transfer signal TX and the reset signal FDRST with respect to the transfer transistors Ttx and the reset transistors Trst of all of the pixels Px are both turned on before the timing T0, resulting in that the charge in the photodiodes PD and the charge in the floating diffusion areas FD are both initialized, and similar to the case of FIG. 7, a voltage Vfd (N+1) of the floating diffusion area FD of the (N+3)-th row at the timing T0 is Vfd_init1.

In FIG. 9, the transfer signal TX and the reset signal FDRST are not output in the correction data obtaining period, so that as the potential Vfd of the floating diffusion area FD, the initialized voltage Vfd_init1 is maintained, and the image data obtaining period starts. Similar to the case of FIG. 7, the exposure is performed before the image data obtaining period starts, and a charge in accordance with an amount of incident light is accumulated in the photodiode PD of each pixel Px. Subsequently, the image data obtaining period starts from the timing T20.

At the timing T21, when the selection signal SEL becomes High and the selection transistor Tsel is turned on, the voltage Vfd of the floating diffusion area FD is read to the vertical signal line VLINE via the amplifying transistor Tamp and the selection transistor Tsel.

At the timing T22, when the reset signal FDRST becomes High and the reset transistor Trst is turned on, the voltage Vfd of the floating diffusion area FD becomes close to the voltage of the power supply VDD. However, because of the characteristic of the on-resistance Ron of the reset transistor Trst, similar to the case of FIG. 7, a potential difference ΔVfd_r_on3 is generated before and after the reset signal FDRST is output, and the potential Vfd_init1 of the floating diffusion area FD before the image data obtaining period starts becomes a potential Vfd_after3 at the timing T23 at which the output of the reset signal FDRST is stopped. Here, although the potential Vfd of the floating diffusion area FD before the image data obtaining period starts was Vfd_after1 in FIG. 7, it is Vfd_init1 in FIG. 9.

At the timings T24 to T25, when the dark sample-and-hold signal DARK_S/H becomes High, a voltage corresponding to the potential Vfd_after3 of the floating diffusion area FD before the charge (signal charge) accumulated in the photodiode PD is transferred to the floating diffusion area FD is held in the dark capacitor Cd.

At the timings T26 to T27, when the transfer signal TX becomes High, the signal charge in the photodiode PD is transferred to the floating diffusion area FD. In this case, since the exposure has been performed, the potential is decreased by a potential difference ΔVfd2 in accordance with the amount of light, resulting in that the floating diffusion area FD has a potential of Vfd_img2.

At the timings T28 to T29, when the signal sample-and-hold signal SIGNAL_S/H becomes High, a voltage corresponding to the potential Vfd_img2 of the floating diffusion area FD after the signal charge in the photodiode PD is transferred to the floating diffusion area FD is held in the signal capacitor Cs.

At the timings T30 to T33, short pulses of the horizontal output signals GH1 to GH4 in FIG. 7 are given by the horizontal driving circuit 155 to the respective signal switches Sso and dark switches Sdo, and the respective signals sampled and held by the signal capacitors Cs and the dark capacitors Cd are sequentially read by the output amplifier AMPout. Subsequently, a signal (ΔVfd2) as a result of subtracting the dark signal (Vfd_after3) from the PD signal (Vfd_img2) in the output amplifier AMPout is output from the solid-state image sensor 103 to the AFE 104.

The image data obtaining period of the (N+1)-th row ends at the timing T40, and similar processing from the timings T20 to T40 is repeatedly conducted with respect to all of the rows from which the unexposed data is not read for obtaining the correction data.

The exposed data output to the AFE 104 as described above is output to the subtraction part 108 via the switch part 105. The subtraction part 108 subtracts the correction data generated by the correction data calculation part 107 in the correction data obtaining period from the exposed data, to thereby create the image data as a result of removing the noise components in the horizontal direction. Here, as the correction data used with respect to the exposed data of the row from which the unexposed data is not read for obtaining the correction data, there is used the correction data obtained from the row from which the unexposed data is read, as described before in FIG. 7. Note that also in this case, the correction data of the column corresponding to the same column of the exposed data is used.

In like manner, image data as a result of correcting the noises in the horizontal direction is determined with respect to the exposed data of all of the rows of the pixel array 151 of the solid-state image sensor 103, and a shot image of one screen can be taken into the image buffer 109.

Here, by comparing the timing charts in FIG. 7 and FIG. 9, explanation will be made on the reason why the signals output from the solid-state image sensor 103 are different between the row from which the unexposed data is read and the row from which the unexposed data is not read in the correction data obtaining period.

Regarding the row illustrated in FIG. 7 from which the unexposed data for creating the correction data is read, the voltage of the dark signal of the floating diffusion area FD is Vfd_after2 and the voltage of the PD signal is Vfd_img1, so that the voltage corresponding to the charge accumulated in the photodiode PD is ΔVfd1.

On the contrary, regarding the row illustrated in FIG. 9 from which the unexposed data for creating the correction data is not read, the voltage of the dark signal of the floating diffusion area FD is Vfd_after3 and the voltage of the PD signal is Vfd_img2, so that the voltage difference corresponding to the charge accumulated in the photodiode PD is ΔVfd2.

Here, since the light incident on the solid-state image sensor 103 is uniform with respect to the entire pixel array 151, each pixel has the same charge accumulated in the photodiode PD. Accordingly, although the potentials Vfd_after2 and Vfd_after3 of the dark signals of the floating diffusion areas FD are different, the potential difference ΔVfd1 and the potential difference ΔVfd2 obtained when the potentials Vfd after transferring the charges accumulated in the photodiodes PD to the floating diffusion areas FD change, become equal.

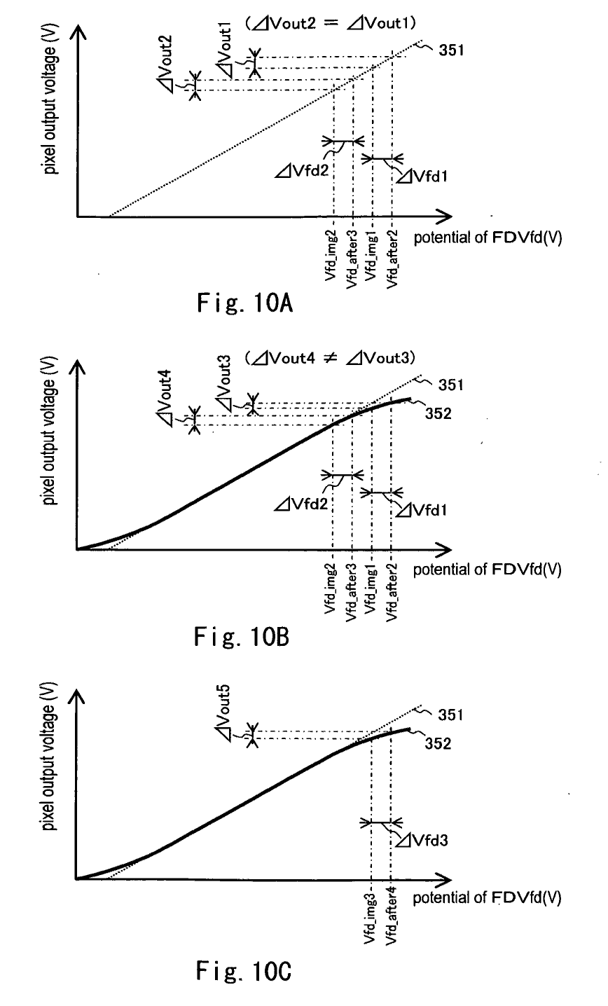

First, by using FIG. 10A, explanation will be made on a case where the pixel amplifiers (amplifying transistors Tamp) are used in an ideal linear region of their input-output characteristics. FIG. 10A is a graph illustrating a relation between the potential Vfd of the floating diffusion area FD and a pixel output voltage (voltage output to the vertical signal line VLINE). Note that in FIG. 10A, the same reference numerals as those of the timing charts in FIG. 7 and FIG. 9 indicate the same elements.

As illustrated in FIG. 10A, when input-output characteristics 351 of the amplifying transistors Tamp are linear, an output voltage of the amplifying transistor Tamp that inputs the potential difference ΔVfd1 of the floating diffusion area FD of the row from which the unexposed data for creating the correction data is read (pixel output voltage read to the vertical signal line VLINE via the selection transistor Tsel) becomes ΔVout1. In like manner, an output voltage of the amplifying transistor Tamp that inputs the potential difference ΔVfd2 of the floating diffusion area FD of the row from which the unexposed data for creating the correction data is not read becomes ΔVout2. Here, as described before, since the input-output characteristics 351 of the amplifying transistors Tamp are linear and the input potential differences ΔVfd1 and ΔVfd2 are equal, the pixel output potential differences ΔVout1 and ΔVout2 become equal.

As above, when the input-output characteristics 351 of the amplifying transistors Tamp are linear, the pixel output voltage of the row from which the unexposed data for creating the correction data is read and that of the row from which the unexposed data for creating the correction data is not read are the same, so that there is no chance that a black band such as one in the image 203 in FIG. 5 appears.

However, when the input-output characteristics 352 of the amplifying transistors Tamp are nonlinear as illustrated in FIG. 10B, the pixel output voltage of the row from which the unexposed data for creating the correction data is read and that of the row from which the unexposed data for creating the correction data is not read are different, resulting in that a black band such as one in the image 203 in FIG. 5 appears. For example, in FIG. 10B, the potential differences ΔVfd1 and ΔVfd2 input into the amplifying transistors Tamp are equal, which is the same as the case of FIG. 10A, but, since the input-output characteristics of the amplifying transistors Tamp are nonlinear such as the input-output characteristics 352, respective output potential differences ΔVout3 and ΔVout4 do not become equal. Here, ΔVout3 is the output potential difference with respect to the input potential difference of ΔVfd1, and ΔVout4 is the output potential difference with respect to the input potential difference of ΔVfd2.

As described above, when the amplifying transistors Tamp are used in the nonlinear region of their input-output characteristics 351, the pixel output voltage of the row from which the unexposed data for creating the correction data is read and that of the row from which the unexposed data for creating the correction data is not read are different, so that a black band such as one in the image 203 in FIG. 5 appears. Further, the electronic camera 100 according to the present embodiment is designed to be able to remove, even when the amplifying transistors Tamp are used in the nonlinear region of their input-output characteristics 351, the noise components in the horizontal direction without deteriorating an image quality as in the image 203.

<Correction Data Obtaining Period in the Present Embodiment>

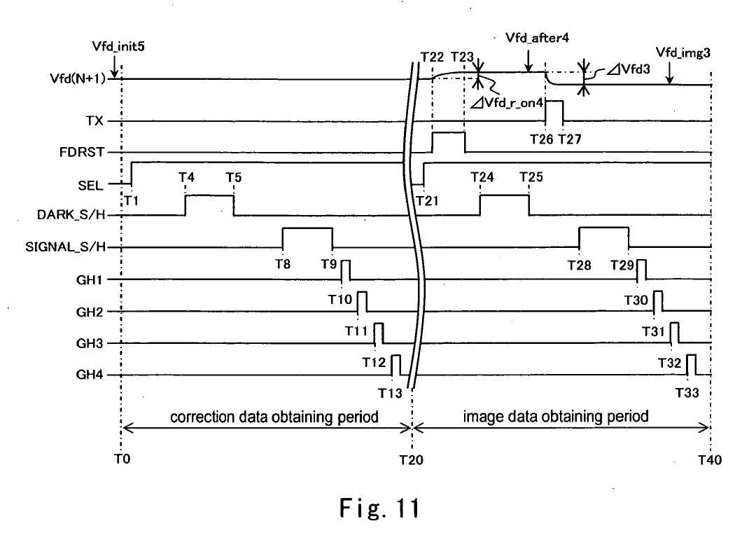

FIG. 11 is a timing chart of a correction data obtaining period and an image data obtaining period in the present embodiment corresponding to the row ((N+1)-th row) from which the unexposed data for creating the correction data is read, similar to FIG. 7. Note that in FIG. 11, the same reference numerals as those in FIG. 7 indicate the same elements. For example, the transfer signal TX, the reset signal FDRST, the selection signal SEL, the dark sample-and-hold signal DARK_S/H, the signal sample-and-hold signal SIGNALS/H, and the horizontal output signals GH1 to GH4 are output at the same timings as those in FIG. 7, from the timings T20 to T40 in the image data obtaining period. In like manner, the selection signal SEL, the dark sample-and-hold signal DARK_S/H, the signal sample-and-hold signal SIGNAL_S/H, and the horizontal output signals GH1 to GH4 in the correction data obtaining period are output at the same timings as those in FIG. 7, at the timings T1, T4, T5 and from the timings T8 to T13 in the correction data obtaining period. What differs from FIG. 7 is that the transfer signal TX and the reset signal FDRST are not output in the correction data obtaining period. For this reason, in the correction data obtaining period, the transfer transistor Ttx and the reset transistor Trst are maintained to be in an off state.

At the timing T1, when the selection signal SEL becomes High and the selection transistor Tsel is turned on, a voltage Vfd of the floating diffusion area FD is read to the vertical signal line VLINE via the amplifying transistor Tamp and the selection transistor Tsel.

At the timings T4 to T5, when the dark sample-and-hold signal DARK_S/H becomes High, a voltage corresponding to a potential Vfd_init5 of the floating diffusion area FD initialized before the timing T0 is read and held in the dark capacitor Cd.

At the timings T8 to T9, when the signal sample-and-hold signal SIGNAL_S/H becomes High, the voltage corresponding to the potential Vfd_init5 of the floating diffusion area FD initialized before the timing T0 is read and held in the signal capacitor Cs.

At the timings T10 to T13, short pulses of the horizontal output signals GH1 to GH4 in FIG. 7 are given by the horizontal driving circuit 155 to the respective signal switches Sso and dark switches Sdo, and the respective signals sampled and held by the signal capacitors Cs and the dark capacitors Cd are sequentially read by the output amplifier AMPout to be output from the solid-state image sensor 103 to the AFE 104.

Here, when unexposed data for creating the correction data is read from the (N+2)-th row as well, the unexposed data is read in the correction data obtaining period in a procedure similar to that of the timing chart regarding the (N+1)-th row described above.

The unexposed data output to the AFE 104 as described above is held in the line memory 106 via the switch part 105, and the correction data is created by the correction data calculation part 107. Note that the correction data calculation part 107 can obtain the correction data of one row by determining the correction data of each column, through the procedure of creating the correction data similar to the procedure explained in FIG. 7.

Next, the image data obtaining period will be explained. In FIG. 11, similar to previously explained FIG. 9, the transfer signal TX and the reset signal FDRST are not output in the correction data obtaining period, so that as the potential Vfd of the floating diffusion area FD, the initialized voltage Vfd_init5 is maintained, and the image data obtaining period starts. Further, similar to the case of FIG. 7, the exposure is performed before the image data obtaining period starts, and a charge in accordance with an amount of incident light is accumulated in the photodiode PD of each pixel Px. Subsequently, the image data obtaining period starts from the timing T20.

At the timings T22 to T23, when the reset signal FDRST becomes High and the reset transistor Trst is turned on, the voltage Vfd of the floating diffusion area FD becomes close to the voltage of the power supply VDD. However, because of the characteristic of the on-resistance Ron of the reset transistor Trst, similar to the case of FIG. 7, a potential difference ΔVfd_r_on4 is generated before and after the reset signal FDRST is output, and the potential Vfd_init5 of the floating diffusion area FD before the image data obtaining period starts becomes a potential Vfd_after4 at the timing T23 at which the output of the reset signal FDRST is stopped.

At the timings T24 to T25, when the dark sample-and-hold signal DARK_S/H becomes High, a voltage corresponding to the potential Vfd_after4 of the floating diffusion area FD before the charge (signal charge) accumulated in the photodiode PD is transferred to the floating diffusion area FD is held in the dark capacitor Cd.

At the timings T26 to T27, when the transfer signal TX becomes High, the signal charge in the photodiode PD is transferred to the floating diffusion area FD. In this case, the potential is decreased by a potential difference ΔVfd3 in accordance with an amount of light provided by the exposure, resulting in that the potential of the floating diffusion area FD becomes Vfd_img3 from Vfd_after4.

At the timings T28 to T29, when the signal sample-and-hold signal SIGNAL_S/H becomes High, a voltage corresponding to the potential Vfd_img3 of the floating diffusion area FD after the signal charge in the photodiode PD is transferred to the floating diffusion area FD is held in the signal capacitor Cs.

At the timings T30 to T33, short pulses of the horizontal output signals GH1 to GH4 in FIG. 7 are given by the horizontal driving circuit 155 to the respective signal switches Sso and dark switches Sdo, and the respective signals sampled and held by the signal capacitors Cs and the dark capacitors Cd are sequentially read by the output amplifier AMPout. Subsequently, a signal (ΔVfd3) as a result of subtracting the dark signal (Vfd_after4) from the PD signal (Vfd_img3) in the output amplifier AMPout is output from the solid-state image sensor 103 to the AFE 104.

The image data obtaining period of the (N+1)-th row ends at the timing T40, and similar processing from the timings T20 to T40 is repeatedly conducted with respect to all of the rows from which the unexposed data is read for obtaining the correction data.

The exposed data output to the AFE 104 as described above is output to the subtraction part 108 via the switch part 105. The subtraction part 108 subtracts the correction data generated by the correction data calculation part 107 in the correction data obtaining period from the exposed data, to thereby create the image data as a result of removing the noise components in the horizontal direction.

In like manner, image data as a result of correcting the noises in the horizontal direction is determined with respect to the exposed data of all of the rows of the pixel array 151 of the solid-state image sensor 103, and a shot image of one screen is taken into the image buffer 109.

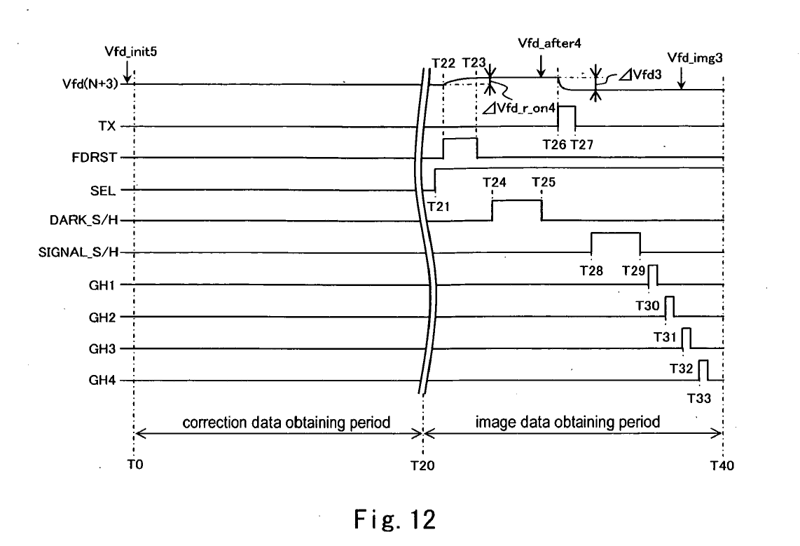

Next, FIG. 12 is a timing chart of a correction data obtaining period and an image data obtaining period in the present embodiment corresponding to the row ((N+3)-th row) from which the unexposed data for creating the correction data is not read. Note that FIG. 12 is a timing chart corresponding to FIG. 9 of the related art. Further, in FIG. 12, elements denoted by the same reference numerals as those in FIG. 11 indicate the same elements. Further, also in FIG. 12, the transfer signal TX and the reset signal FDRST with respect to the transfer transistors Ttx and the reset transistors Trst of all of the pixels Px are both turned on before the timing T0, resulting in that the charge in the photodiodes PD and the charge in the floating diffusion areas FD are both initialized, and similar to the case of FIG. 11, a voltage Vfd (N+1) of the floating diffusion area FD of the (N+3)-th row at the timing T0 is Vfd_init5.

In FIG. 12, the transfer signal TX and the reset signal FDRST are not output in the correction data obtaining period, so that the potential Vfd of the floating diffusion area FD when the image data obtaining period starts corresponds to the initialized voltage Vfd_init5 which is in a state of being maintained. Further, the exposure is performed before the image data obtaining period starts, a charge in accordance with an amount of incident light is accumulated in the photodiode PD of the pixel Px, and thereafter, the image data obtaining period starts from the timing T20. Here, operations from the timings T21 to T40 are the same as those in FIG. 11, in which the potential of the floating diffusion area FD after the reset signal FDRST is output at the timings T22 to T23 becomes Vfd_after4 by being increased by ΔVfd_r_on4 because of the on-resistance Ron of the reset transistor Trst. Further, by the transfer signal TX output at the timings T26 to T27, the potential Vfd of the floating diffusion area FD becomes Vfd_img3 by being decreased by ΔVfd3 in accordance with the charge accumulated in the photodiode PD, similar to the case of FIG. 11.

As described above, the potential Vfd_after4 before transferring the charge accumulated in the photodiode PD to the floating diffusion area FD and the potential Vfd_img3 after the charge is transferred in the row from which the unexposed data for creating the correction data is read and those in the row from which the unexposed data is not read, are respectively the same. For this reason, even when the pixel amplifiers (amplifying transistors Tamp) are used in the nonlinear region of their input-output characteristics, the output voltage of the amplifying transistor Tamp (pixel output voltage read to the vertical signal line VLINE via the selection transistor Tsel) in the row from which the unexposed data for creating the correction data is read and that in the row from which the unexposed data is not read, take the same potential difference ΔVout5, as illustrated in FIG. 10C. This is because the operating point of the amplifying transistor Tamp of the pixel Px does not change since no driving such as one for giving potential variation to the floating diffusion area FD of each pixel Px of the row from which the unexposed data for obtaining the correction data is performed.

As described above, in the electronic camera 100 in the present embodiment, even when the input-output characteristics 351 of the amplifying transistors Tamp are nonlinear, the pixel output voltage of the row from which the unexposed data for creating the correction data is read and that of the row from which the unexposed data for creating the correction data is not read are the same, so that there is no chance that a fixed pattern noise such as one in the image 203 in FIG. 5 appears.

Note that in the present embodiment, explanation was made by citing the electronic camera 100 as an example, but, it is also possible that, instead of using the electronic camera 100, a correction circuit that performs operations similar to those of the correction data calculation part 107 and the subtraction part 108 is provided inside the solid-state image sensor 103, for example.

As described above, the electronic camera 100 according to the present embodiment can remove, even when the amplifying transistors Tamp are used in the nonlinear region of their input-output characteristics 351, the noise components in the horizontal direction without deteriorating the image quality as in the image 203 in FIG. 5, resulting in that a high-quality shot image can be obtained.

As above, the image shooting device according to the present invention has been described by citing examples in the respective embodiments, but, the present invention can be embodied in other various forms without departing from the spirit or essential characteristics thereof. The above embodiments are therefore to be considered in all respects as illustrative and not restrictive. The present invention is indicated by the scope of appended claims, and in no way limited by the text of the specification. Moreover, all modifications and changes that fall within the equivalent scope of the appended claims are deemed to be within the scope of the present invention.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image shooting device, comprising:
an image shooting part formed of a pixel array and a reading control part, in which the pixel array includes a plurality of pixels arranged in a matrix form, each of the pixels having a photoelectric conversion part which accumulates a charge in accordance with an amount of light, a transfer transistor which transfers the charge to a floating diffusion area, an amplifying transistor which outputs a pixel signal in accordance with the charge held in the floating diffusion area, and a reset transistor which resets the charge held in the floating diffusion area, and the reading control part performs reading by switching a first reading control in which the reset transistor is controlled to be turned off before exposure to read the pixel signal from a part of rows of the pixel array and a second reading control in which the pixel signal is read from the pixel array after the exposure; and
a correcting part correcting the pixel signal read through the second reading control based on the pixel signal read through the first reading control.

2. The image shooting device according to claim 1, wherein
in the first reading control, the transfer transistor is controlled to be turned off to read the pixel signal from the part of rows of the pixel array.

3. The image shooting device according to claim 1, wherein
in the first reading control, the reset transistor of a row from which the pixel signal is not read is controlled to be turned off.

4. The image shooting device according to claim 2, wherein
in the first reading control, the reset transistor of a row from which the pixel signal is not read is controlled to be turned off.

5. The image shooting device according to claim 1, wherein
in the first reading control, the pixel signal of a row located at a center portion of the pixel array is read.

6. The image shooting device according to claim 2, wherein
in the first reading control, the pixel signal of a row located at a center portion of the pixel array is read.

7. The image shooting device according to claim 3, wherein
in the first reading control, the pixel signal of a row located at a center portion of the pixel array is read.

8. The image shooting device according to claim 4, wherein
in the first reading control, the pixel signal of a row located at a center portion of the pixel array is read.
